(19) United States
(12) Patent Application Publication
(10) Pub. No.: US 2005/0187065 A1
(43) Pub. Date: Aug. 25, 2005

(54) Manufacturing method for variator part of torodidal-type continuously variable transmission, variator part of toroidal-type continuously variable transmission and toroidal-type continuously variable transmission

(75) Inventors: Kiyotaka Hirata, Kanagawa (JP); Yoshisada Imai, Saitama (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/062,941

(22) Filed: Feb. 23, 2005

(30) Foreign Application Priority Data
Feb. 24, 2004 (JP) P.2004-047835

(51) Int. Cl. F16C 19/00; F16H 15/38

(52) U.S. Cl. 476/40

(57) ABSTRACT

A manufacturing method for a variator part of a toroidal-type continuously variable transmission, has the steps of preparing a lower die including a first hole portion and a ring-like projected portion, wherein center lines of the first hole portion and the ring-like projected portion coincide with each other, and an upper die including a second hole portion, wherein a center line of the second hole portion is eccentric from the center line of the first hole portion, mounting a solid material on the lower die so that a center line of the solid material coincides with the center line of the ring-like projected portion, and simultaneously forming the support shaft portion, the outer ring and the pivot shaft portion by pressing the upper die and the lower die so as to approach each other.

The present invention claims foreign priority to Japanese patent application no. P. 2004-047835, filed on Feb. 24, 2004, the contents of which is incorporated herein by reference.

### BACKGROUND OF THE INVENTION

1. Field of the Invention

The present invention relates to a manufacturing method for a variator part of a toroidal-type continuously variable transmission utilized as a transmission of an automobile part or a transmission of an industrial machine or the like, a variator part of a toroidal-type continuously variable transmission and a toroidal-type continuously variable transmission.

2. Description of the Related Art

In recent years, there has been researched to use a toroidal-type continuously variable transmission as a transmission for an automobile (refer to, for example, Japanese Patent Unexamined Publication No. JP-A-11-51140). As shown in FIG. 3, a toroidal-type continuously variable transmission 1 is provided with a variator part combining an input disk 3 and an output disk 4 which are rotatably supported at a surrounding of an input shaft 2 concentrically with each other and independently from each other and inner side faces 3a, 4a of which are opposed to each other, and a rotatable power roller 5 pinched between the inner side faces of the input disk 3 and the output disk 4.

A cam plate 6 is provided to engage with the input shaft 2 by a spline on a back face side of the input disk 3. Further, a roller 7 is interposed between the cam plate 6 and the input disk 3 to constitute a pressing apparatus 8 of a loading cam type for pressing the input disk 3 to a side of the output disk 4.

A trunnion 10 swung centering on a pivot shaft 9 along a direction substantially orthogonal to center axes of the input disk 3 and the output disk 4 is provided between the input disk 3 and the output disk 4. The trunnion 10 is arranged with a displacement shaft 11 extended in a direction substantially orthogonal to the pivot shaft 9 substantially at a center thereof and the power roller 5 is rotatably supported by the displacement shaft 11.

According to the above-described toroidal-type continuously variable transmission 1, rotation of the input shaft 2 is transmitted to the input disk 3 via the pressing apparatus 8. Further, rotation of the input disk 3 is transmitted to the output disk 4 via the power roller 5, further, rotation of the output disk 4 is outputted by an output gear 12 coupled to the output disk 4 by a key. By changing an inclination angle of the power roller 5 by displacing the trunnion 10, the power roller 5 changes positions of being brought into contact with the input disk 3 and the output disk 4, and a desired rotational speed ratio (transmission ratio) is continuously provided between the input shaft 2 and the output gear 12.

As shown in FIG. 4, the displacement shaft 11 is supported by a circular hole 13 formed at a middle portion of the trunnion 10. The displacement shaft 11 includes a support shaft portion 14 and a pivot shaft portion 15 in parallel with each other and eccentric to each other. The support shaft portion 14 is swingably supported by the trunnion 10 via a radial needle roller bearing 16, and the pivot shaft portion. 15 is projected from an inner side face of the trunnion 10 and rotatably supports the power roller 5 via a radial needle bearing 17.

Further, there are provided a thrust ball bearing 18 for supporting a thrust load applied to the power roller 5 and a thrust needle roller bearing 20 for supporting a thrust load applied to an outer ring 19 constituting the thrust ball bearing 18 in this order from a side of an outer side face of the power roller 5 between the outer side face of the power roller 5 and an inner side face of the middle portion of the trunnion 10. The thrust ball bearing 18 allows the power roller 5 to rotate while supporting the thrust load applied to the power roller 5. Further, the thrust needle roller bearing 20 allows the support shaft portion 15 and the outer ring 19 to swing centering on the support shaft portion 14 while supporting the thrust load applied from the power roller 5 to the outer ring 19.

Therefore, a high face pressure by relative rotational movement which is carried out between a ring-like raceway groove 5a of the outer side face of the power roller 5 constituting an inner ring of the thrust ball bearing 18 and a ring-like raceway groove 19a of the outer ring 19 via a ball 21 is generated at the ring-like raceway groove 19a of the outer ring 19 and a repeated stress is generated at the ring-like raceway groove 19a. Therefore, it is known to form a metal flow along the raceway groove 19a at the ring-like raceway groove 19a of the outer ring 19 of the thrust ball bearing 18 (refer to, for example, U.S. Pat. No. 6,196,946).

According to a manufacturing method described in U.S. Pat. No. 6,196,946, a disk-like material an outer diameter of which is widened is constituted by press-forging a solid cylindrical material a metal flow of which is extended in an axial direction and the metal flow at a surface is extended in an outer peripheral direction. Further, as shown in FIG. 5, by forming the ring-like raceway groove 19a by forging, the metal flow is formed along the ring-like raceway groove 19a. Therefore, the outer ring 19 of the thrust ball bearing 18 having long service life is formed without producing an end flow at the ring-like raceway groove 19a.

Further, there is known a structure of promoting a speed changing characteristic by restraining an inclination of the displacement shaft 11 by constraining the displacement shaft 11 by the outer ring 19 of the thrust ball bearing 18 by integrally forming the displacement shaft 11 with the outer ring 19 of the thrust ball bearing 18 (refer to, for example, U.S. Pat. No. 6,152,850 and Japanese Patent Unexamined Publication No. JP-A-2002-181151). According to the toroidal-type continuously variable transmission described in JP-A-2002-181151. As shown in FIG. 6, the displacement shaft 11 and the outer ring 19 of the thrust ball bearing 18 are integrated, further, in order to promote durability of a variator part 30 integrated therewith, shot peening or the like is applied to a corner portion between the support shaft portion 14 and the outer ring 19, a corner portion between the outer ring 19 and the pivot shaft portion 15, and a corner portion between a large diameter portion and a small diameter portion of the pivot shaft portion 15 at which stress concentration is generated to provide a compressive residual stress.

Meanwhile, in a related art, in fabricating the variator part 30 integrated in this way, as shown in FIG. 7A, the support shaft portion 14 eccentric to the pivot shaft portion 15 is formed coaxially with the pivot shaft portion 15. Therefore, when a desired outer diameter Da is machined by turning from a forging material W, machining is carried out while rotating a work around a machining rotational center Ca of the support shaft portion 14. In this case, a radius dimension Ra machined by a turning bit is represented by Ra≧2E+a (E: an amount of an eccentricity between the support shaft portion 14 and the pivot shaft portion 15, a: minimum machining margin). Therefore, there poses a problem that the machining margin is large, yield of the material is poor and working time in machining is also prolonged.

Further, it is known that according to the forging material W formed coaxially as shown in FIG. 7B, when the support shaft portion 14 is machined, as shown in FIG. 7C, at a root portion 14a of the support shaft portion 14, the metal flow is cut by machining. That is, there poses a problem that the metal flow around the support shaft portion 14 of the forging material W of the related art constitutes an end flow substantially over an entire periphery thereof and the strength is reduced.

### SUMMARY OF THE INVENTION

The present invention has been carried out in view of the above-described problem and an object thereof is to provide a manufacturing method for a variator part of a toroidal-type continuously variable transmission in which a displacement shaft and an outer ring of a thrust rolling bearing are integrated at low cost by restraining an increase in fabrication cost by improving yield of a material and shorting machining time while increasing a strength thereof, a variator part of a toroidal-type continuously variable transmission and a toroidal-type continuously variable transmission.

According to a first aspect of the present invention, there is provided a manufacturing method for a variator part of a toroidal-type continuously variable transmission, the toroidal-type continuously variable transmission comprising:

input and output disks;

a trunnion;

a power roller;

a displacement shaft including:
a support shaft portion swingably supported by the trunnion; and
a pivot shaft portion disposed in parallel and eccentric to the support shaft portion, the pivot shaft portion rotatably supporting the power roller; and

a thrust rolling bearing including an outer ring on which an outer ring raceway is formed, the thrust rolling bearing supporting a thrust load of the power roller while allowing the power roller to rotate,

wherein the variator part is integrally formed with the displacement shaft and the outer ring of the thrust rolling bearing,

the manufacturing method comprising the steps of:

a first step of preparing a lower die including a first hole portion for forming the pivot shaft portion and a ring-like projected portion for forming the outer ring raceway of the outer ring, wherein center lines of the first hole portion and the ring-like projected portion coincide with each other, and an upper die including a second hole portion for forming the support shaft portion, wherein a center line of the second hole portion is eccentric from the center line of the first hole portion by a predetermined value;

a second step of mounting a solid material on the lower die so that a center line of the solid material coincides with the center line of the ring-like projected portion; and

a third step of simultaneously forming the support shaft portion, the outer ring having the outer ring raceway and the pivot shaft portion by pressing the upper die and the lower die so as to approach each other.

According to a second aspect of the present invention as set forth in the first aspect of the present invention, it is preferable that the solid material is formed by forging a cylindrical solid material having a diameter smaller than an inner diameter of the outer ring raceway before the third step.

According to a third aspect of the present invention as set forth in the first aspect of the present invention, it is more preferable that the upper die is pressed to the lower die at the third step.

According to a fourth aspect of the present invention as set forth in the first aspect of the present invention, it is furthermore preferable that the manufacturing method for the variator part of the toroidal-type continuously variable transmission comprising a step of:

a fourth step of machining a finishing margin formed around the variator part in a substantially same shape of the variator part.

According to a fifth aspect of the present invention, there is provide a variator part of a toroidal-type continuously variable transmission, the toroidal-type continuously variable transmission comprising:

an input disk and an output disk;

a trunnion;

a power roller;

a displacement shaft including:
a support shaft portion swingably supported by the trunnion; and
a pivot shaft portion disposed so as to be parallel with and eccentric to the support shaft portion, and rotatably supporting the power roller; and

a thrust rolling bearing including an outer ring on which a outer ring raceway is formed, the thrust rolling bearing supporting a thrust load of the power roller while allowing the power roller to rotate;

wherein the variator part is integrally formed with the displacement shaft and the outer ring of the thrust rolling bearing,

wherein the variator part is formed such that

a solid material is mounted on a lower die such that a center line of the solid material coincides with a center line of a ring-like projected portion of a lower die; and

the support shaft portion, the outer ring having the outer ring raceway and the pivot shaft portion of the variator part are simultaneously formed of the solid material by pressing an upper die and the lower die so as to approach each other,
wherein the lower die includes a first hole portion for forming the pivot shaft portion and the ring-like projected portion for forming the outer ring raceway of the outer ring, wherein center lines of the first hole portion and the ring-like projected portion coincide with each other, and
the upper die includes a second hole portion for forming the support shaft portion, wherein a center line of the second hole portion is eccentric from the center line of the first hole portion by a predetermined value, and

wherein metal flows extends along with the outer ring raceway and a surface of a root portion of the support shaft portion of the displacement shaft.

According to a sixth aspect of the present invention as set forth in the fifth aspect of the present invention, it is suitable that an end of the metal flow is disposed on a side surface of the support shaft portion of the displacement shaft.

According to a seventh aspect of the present invention, there is provided a toroidal-type continuously variable transmission, comprising:

a variator part according to the fifth aspect of the present invention; and

an input and output disks rotatably supported so as to be mutually independent.

According to an eighth aspect of the present invention there is provided a toroidal-type continuously variable transmission, comprising:

input and output disks, which are rotatably supported so as to be mutually independent and have inner surfaces thereof;

a trunnion having a pivot shaft disposed in a direction perpendicular to a center axis of the input and output disks, the trunnion swinging on the pivot shaft;

a displacement shaft including:
a support shaft portion swingably supported on the trunnion; and
a pivot shaft portion disposed in parallel and eccentric with the support shaft portion, the pivot shaft portion protruded from an inner surface of the trunnion;

a plurality of power rollers pinched between the inner surfaces of the input and output disks and rotatably supported on the pivot shaft portion; and

a thrust rolling bearing provided between an outer surface of the power roller and the inner surface of the trunnion, the thrust rolling bearing including:
an outer ring;
an inner ring raceway formed on the outer surface of the power roller;
an outer ring raceway formed on the inner surface of the outer ring; and
a rolling element rollably disposed between the inner ring raceway and the outer ring raceway,

wherein the displacement shaft and the outer ring of the thrust rolling bearing are integrated and

metal flows extends along with the outer ring raceway and a surface of a root portion of the support shaft portion of the displacement shaft.

Note that the metal flow means stream line which is generated in metal when the metal is flowed in pressurized such as forging.

According to the manufacturing method for a variator part of a toroidal-type continuously variable transmission of the present invention, the support shaft portion formed on an side opposed to the outer ring raceway of the outer ring is forged by the second hole portion of the upper die having the center line at the position eccentric from the center line of the lower die by the predetermined amount. Therefore, the forging material along a desired product shape can be provided. Thereby, a machining margin in turning the support shaft portion can be made to be necessary minimum and machining time can be shortened.

Further, by forging as described above, at a root portion of the support shaft portion disposed in a direction in which the support shaft portion is eccentric to the pivot shaft portion, a metal flow is formed along a surface thereof. Therefore, even when a stress is applied to the support shaft portion by deforming the outer ring, a strength of the root portion of the support shaft portion can be prevented from being reduced.

Further, forging is carried out by making an outer diameter of the solid material smaller than the inner diameter of the ring-like raceway groove and making the center line of the solid material coincide with the centerline of the ring-like projected portion forming the outer ring raceway of the outer ring of the solid material. Accordingly, an end flow of an end face of the solid material is not extruded into the outer ring raceway of the outer ring and a metal flow along a surface of the outer ring raceway can be provided. Therefore, even when a repeated stress is operated by relative rotational movement of the thrust ball bearing, the stress can be prevented from being reduced at the outer ring raceway.

Further, according to the toroidal-type continuously variable transmission of the present invention, the displacement shaft and the outer ring of the thrust rolling bearing are integrated, metal flows at the outer ring raceway of the outer ring and the root portion of the support shaft portion are extended along surfaces thereof. Accordingly, even when the repeated stress is operated by the relative rotational movement of the thrust ball bearing, the strength can be prevented from being reduced at the outer ring raceway and even when the stress is operated at the support shaft portion by deforming the outer ring, the strength can be prevented from being reduced at the root portion of the support shaft portion.

### BRIEF DESCRIPTION OF THE DRAWINGS

FIG. 1 is a view showing a variator part of a toroidal-type continuously variable transmission of the present invention;

FIG. 2A to 2E illustrate views for explaining steps of forging the variator part of FIG. 1;

FIG. 3 is a sectional view of an essential portion showing a specific constitution of a toroidal-type continuously variable transmission;

FIG. 4 is a sectional view showing a trunnion attached with a power roller of the related art;

FIG. 5 is a view showing a step of punching an outer ring of a thrust rolling bearing of the related art.

FIG. 6 is a sectional view of a variator part of the related art in which a displacement shaft and an outer ring of the thrust rolling bearing are integrated.

FIG. 7A is a view showing a material after forging an integrated variator part of the related art;

FIG. 7B is a view showing a metal flow of the variator part as forged; and

FIG. 7C is a view enlarging a C portion of FIG. 7B.

### DETAILED DESCRIPTION OF THE PREFERRED EMBODIMENTS

A manufacturing method for a variator part of a toroidal-type continuously variable transmission, a variator part of a toroidal-type continuously variable transmission and a toroidal-type continuously variable transmission according to the present invention will be explained in details in reference to the drawings as follows. Further a characteristic of the present invention resides in a manufacturing method for a variator part in which a displacement shaft and an outer ring of a thrust rolling bearing are integrated and the variator part. The other structure and operation are similar to those of a toroidal-type continuously variable transmission which has been known in a related art including the above-described structure of the related art. Therefore, an explanation will be omitted or simplified with regard to portions equivalent to those of the structure of the related art and an explanation will be given centering on a characteristic portion of the present invention.

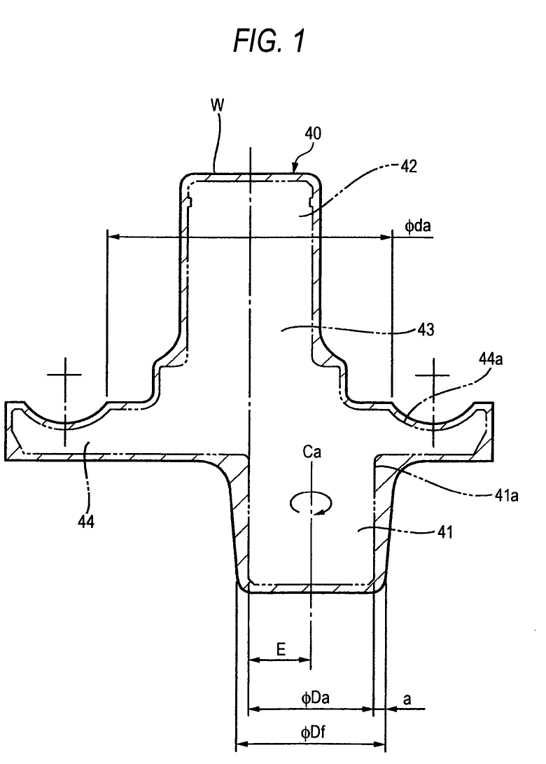

FIG. 1 shows a variator part of a toroidal-type continuously variable transmission applied to the variator part of the related art of FIG. 6 in which the displacement shaft and the outer ring of the thrust ball bearing are integrated and fabricated by the fabricating method of the present invention. Further, the variator of FIG. 1 shows a shape of a material as forged and a portion indicated by hatched lines represents a machining margin. Therefore, a portion indicated by a chain double-dashed line shows a shape of a product of the variator part.

A variator part 40 according to the embodiment of the present invention is integrally formed with a displacement shaft 43 having a support shaft portion 41 swingably supported by the trunnion 10 (refer to FIG. 6), and a pivot shaft portion 42 in parallel with and eccentric to the support shaft portion 41 for rotatably supporting the power roller 5 (refer to FIG. 6), and an outer ring 44 of a thrust ball bearing (thrust rolling bearing) for supporting a thrust load of the power roller 5. A side of the pivot shaft portion of the outer ring 44 is formed with an outer ring raceway 44a for supporting the plurality of balls 21 (refer to FIG. 6) along with the inner ring raceway 5a (refer to FIG. 6) formed at the outer side face of the power roller 5. As is known from FIG. 1, the forging material W is formed to be large by an amount of a machining margin in a form substantially along a shape of a product.

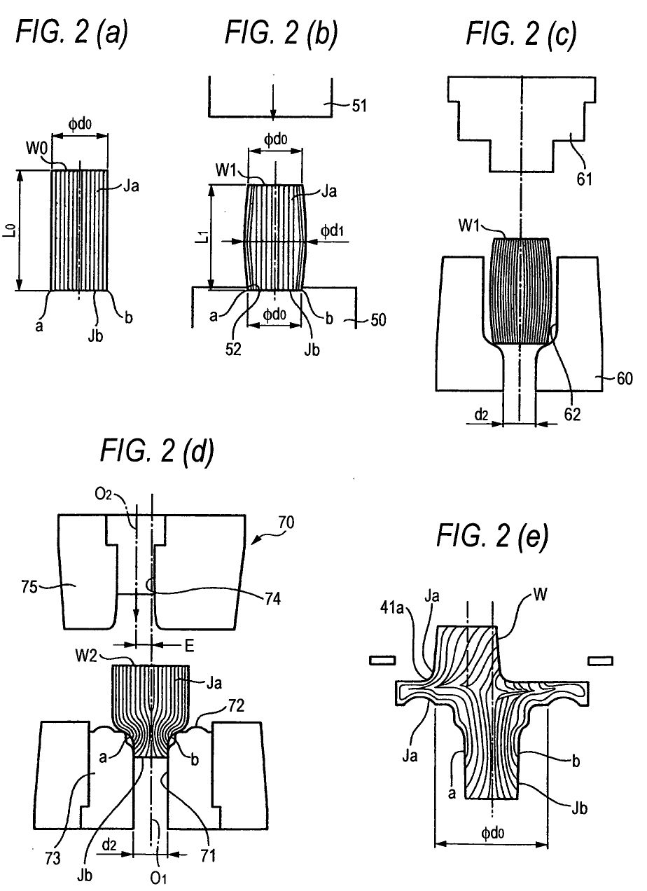

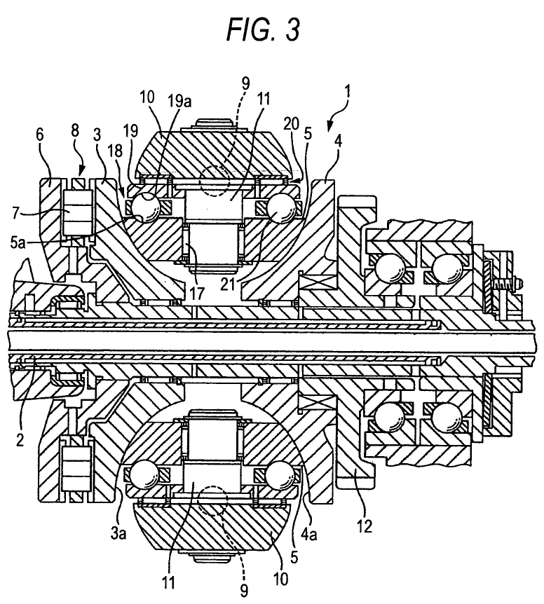

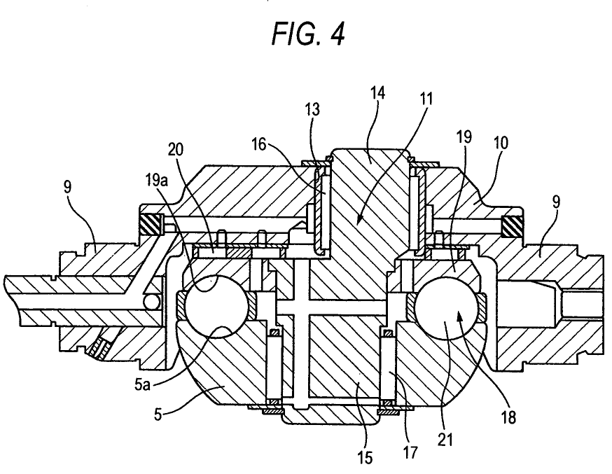

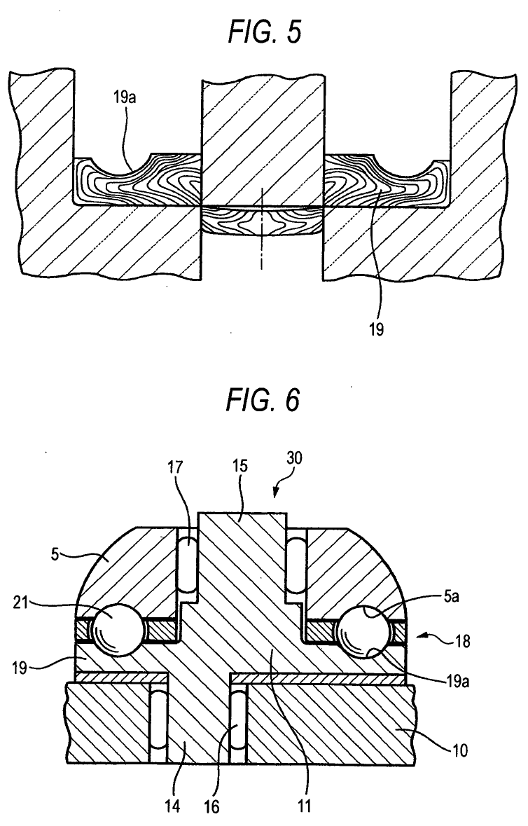

Next, a manufacturing method for the variator part 40 constituted in this way will be explained in reference to FIG. 2.

First, as shown in FIG. 2A, a long cylindrical solid material having an outer diameter dimension of φd0 is cut to a predetermined length L0 by using a saw machine or a billet shear. Here, the outer diameter φd0 of the solid material is set to φd0<φda such that the outer diameter φd0 is disposed on an inner side of an outer ring raceway inner diameter φda finished with forming. Further, the outer diameter φd0 and the length L0 of the cut solid material W0 are set to be L0/φd0≦2.5 while ensuring a volume which is not excessive or deficient in achieving the product shape. Further, L0/φd0≦2.5 is set to prevent the solid material W0 from being buckled in a later swaging step. For example, when L0 is excessively long relative to φd0, there is a possibility that in the midst of swaging, the solid material W0 is easy to bend to be buckled and a metal flow Ja is bent.

Next, the solid material W0 cut as described above is heated to a temperature suitable for forging. Further, as shown in FIG. 2B, the heated solid material W0 is crushed by a lower die 50 and an upper die 51 arranged on both sides in an axial direction thereof and swaging is carried out by constituting a limit to a swaged outer diameter φd1 which can be inserted into a die of a successive rough forging step. Here, when swaging is intensified and L1/L0 is reduced, there is a possibility that the material is buckled and the metal flow Ja is bent and the pivot shaft portion 42 cannot be extruded frontward in a later step. Therefore, a length L1 of the solid material W1 as swaged in set to be L1/L0≧0.7. Further, with regard to the dies for swaging, it is preferable to form a circular recessed portion 52 on at least one of the upper die 50 and the lower die 51 in order to prevent the solid material W1 from being fallen and also prevent the end face outer diameter φd0 from being enlarged. Here, a range a-b of an end flow Jb in the swaging is disposed within a range of the recessed portion 52.

Next, as shown in FIG. 2C, there is carried out rough forging with an object of extruding the pivot shaft portion 42 frontward and preparatorily forming the outer ring 44 in a flange-like shape having the outer ring raceway. At this occasion, a lower die 60 is provided with a cylindrical portion 62 having a diameter larger than the outer diameter φd1 of the solid material W1, and a hole portion 63 communicated with the cylindrical portion 62 and having an outer diameter φd2 for preparatorily forming the pivot shaft portion 42 and forging is carried out under a state in which a center line of the solid material W1 and center lines of the lower die 60 and an upper die 61 substantially coincide with each other.

Further, final finish forging is carried out by a finish die as shown in FIG. 2D. According to the step, the pivot shaft portion 42 is extruded frontward, the outer ring raceway 44a is formed and the pivot shaft portion 41 is formed simultaneously. The finish die includes a lower die 73 having a first hole portion 71 for forming the pivot shaft portion 42 and a ring-like projected portion 72 for forming the outer ring raceway 44a of the outer ring 44 center lines of which coincide with each other, and an upper die 75 having a second hole portion 74 having a center line O2 eccentric to a center line O1 of the first hole portion 71 and the ring-like projected portion 72 by a predetermined amount E for forming the support shaft portion 41.

By inserting a portion of a solid material W2 having the outer diameter φd2 extruded in the rough forging step into the first hole portion 71, the solid material W2 is mounted to the lower die 73 in a state of aligning a center line of the solid material W2 and the center line O1 of the lower die 73. Further, by pressing to pressurize the upper die 75 to the lower die 73, the support shaft portion 41, the outer ring 44 having the outer ring raceway 44a and the pivot shaft portion 42 are simultaneously formed.

Thereafter, there is carried out trimming for punching and removing an extra burr portion extruded by finish forging.

According to the forging material W provided in this way, a range in which an end flow Jb is present is disposed on a lower side of an outer periphery defined by a range of points between a and b. As shown in FIG. 2E, the metal flow Ja at the outer ring raceway 44a of the outer ring 44 is formed along the surface. Therefore, even when a repeated stress is operated by relative rotational movement of the thrust ball bearing, the strength can be prevented from being reduced. Further, even at a root portion 41a of the support shaft portion 41 disposed in a direction in which the support shaft portion 41 is eccentric to the pivot shaft portion 42, the metal flow Ja is formed along the surface. Accordingly, the strength can more be prevented from being reduced than that at least by the forging method of the related art against a bending stress inputted to the portion.

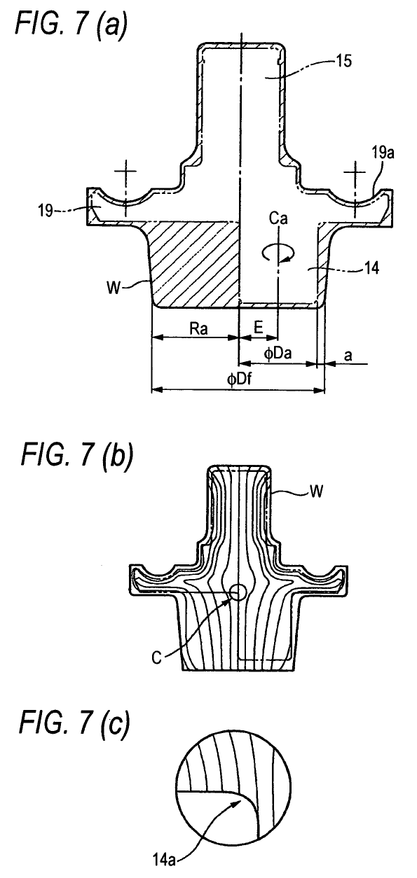

Further, an end of the metal flow is disposed on a side surface of the support shaft portion of the displacement shaft, which is clearly different from the metal flow as shown in FIG. 7B.

Further, the provided forging material W is machined to a rough shape having a finishing margin at a necessary portion. Further, when the support shaft portion 41 is machined by turning the material W, by making the center Ca of the support shaft portion 41 coincide with a center of a principal spindle of a lathe, rotating the forging material W and moving a machining tool, the support shaft portion 41 is machined to a desired rough shape. Therefore, the machining margin Ra in turning the support shaft portion 41 becomes Ra≧a and a machining amount of an amount of 2E can be reduced in comparison with that in machining of the related art.

Further, desired surface hardness and mechanical strength are increased by a heat treatment, machining or polishing is carried out at a functionally necessary portion and the final product shape of the variator part 40 is provided.

As described above, according to the embodiment of present invention, forging is carried out by making the outer diameter φd0 of the solid material smaller than the inner diameter φda of the outer ring raceway 44a of the outer ring 44 and making the center line of the solid material coincide with the center line 01 of the ring-like projected portion 72 forming the outer ring raceway and therefore, the end flow Jb of the end face of the solid material is not extruded into the outer ring raceway 44a and the metal flow Ja along the surface of the outer ring raceway 44a can be provided. Therefore, even when the repeated stress is operated by relative rotational movement of the thrust ball bearing, the strength can be prevented from being reduced at the outer ring raceway 44a.

Further, the support shaft portion 41 formed on a side opposed to the outer ring raceway 44a is forged by the second hole portion 74 of the upper die 75 having the center line O₂ at the position eccentric from the center line O₁ of the lower die 73 by the predetermined amount E and therefore, the forging material W along the desired product shape can be provided. Thereby, the machining margin Ra in turning the support shaft portion 41 can be minimized and machining time can be shortened.

Further, by forging as described above, the metal flow Ja is formed along the surface at the root portion 41a of the support shaft portion 41 disposed in the direction in which the support shaft portion 41 is eccentric to the pivot shaft portion 42. Therefore, even when stress is operated to the support shaft portion 41 by deforming the outer ring 44, the strength can be prevented from being reduced at the root portion 41a of the support shaft portion 41.

Further, the present invention is not limited to the embodiment and the example, mentioned above, but can pertinently be modified or improved.

The variator part of the toroidal-type continuously variable transmission of the present invention is applicable not only to a toroidal-type continuously variable transmission of a single cavity-type but also to that of a double cavity type. Further, although according to the embodiment of the present invention, the variator part is applied to a half toroidal-type continuously variable transmission, the present invention is applicable also to a full toroidal-type continuously variable transmission.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

1. A manufacturing method for a variator part of a toroidal-type continuously variable transmission, the toroidal-type continuously variable transmission comprising:
input and output disks;
a trunnion;
a power roller;
a displacement shaft including:
a support shaft portion swingably supported by the trunnion; and
a pivot shaft portion disposed in parallel and eccentric to the support shaft portion, a pivot shaft portion rotatably supporting the power roller; and
a thrust rolling bearing including an outer ring on which an outer ring raceway is formed, the thrust rolling bearing supporting a thrust load of the power roller while allowing the power roller to rotate,
wherein the variator part is integrally formed with the displacement shaft and the outer ring of the thrust rolling bearing,
the manufacturing method comprising the steps of:
a first step of preparing a lower die including a first hole portion for forming the pivot shaft portion and a ring-like projected portion for forming the outer ring raceway of the outer ring, wherein center lines of the first hole portion and the ring-like projected portion coincide with each other, and an upper die including a second hole portion for forming the support shaft portion, wherein a center line of the second hole portion is eccentric from the center line of the first hole portion by a predetermined value;
a second step of mounting a solid material on the lower die so that a center line of the solid material coincides with the center line of the ring-like projected portion; and
a third step of simultaneously forming the support shaft portion, the outer ring having the outer ring raceway and the pivot shaft portion by pressing the upper die and the lower die so as to approach each other.

2. The manufacturing method for the variator part of the toroidal-type continuously variable transmission according to claim 1, wherein the solid material is formed by forging a cylindrical solid material having a diameter smaller than an inner diameter of the outer ring raceway before the third step.

3. The manufacturing method for the variator part of the toroidal-type continuously variable transmission according to claim 1, wherein the upper die is pressed to the lower die at the third step.

4. The manufacturing method for the variator part of the toroidal-type continuously variable transmission according to claim 1, further comprising a step of:
a fourth step of machining a finishing margin formed around the variator part in a substantially same shape of the variator part.

5. A variator part of a toroidal-type continuously variable transmission, the toroidal-type continuously variable transmission comprising:
an input disk and an output disk;
a trunnion;
a power roller;
a displacement shaft including:
a support shaft portion swingably supported by the trunnion; and
a pivot shaft portion disposed so as to be parallel with and eccentric to the support shaft portion, and rotatably supporting the power roller; and
a thrust rolling bearing including an outer ring on which a outer ring raceway is formed, the thrust rolling bearing supporting a thrust load of the power roller while allowing the power roller to rotate;
wherein the variator part is integrally formed with the displacement shaft and the outer ring of the thrust rolling bearing,
wherein the variator part is formed such that
a solid material is mounted on a lower die such that a center line of the solid material coincides with a center line of a ring-like projected portion of a lower die; and
the support shaft portion, the outer ring having the outer ring raceway and the pivot shaft portion of the variator part are simultaneously formed of the solid material by pressing an upper die and the lower die so as to approach each other,
wherein the lower die includes a first hole portion for forming the pivot shaft portion and the ring-like projected portion for forming the outer ring raceway of the outer ring, wherein center lines of the first hole portion and the ring-like projected portion coincide with each other, and
the upper die includes a second hole portion for forming the support shaft portion, wherein a center line of the second hole portion is eccentric from the center line of the first hole portion by a predetermined value, and
wherein metal flows extends along with the outer ring raceway and a surface of a root portion of the support shaft portion of the displacement shaft.

6. The variator part of the toroidal-type continuously variable transmission according to claim 5, wherein an end of the metal flow is disposed on a side surface of the support shaft portion of the displacement shaft.

7. A toroidal-type continuously variable transmission, comprising:
a variator part according to claim 5; and
an input and output disks rotatably supported so as to be mutually independent.

8. A toroidal-type continuously variable transmission, comprising:
input and output disks, which are rotatably supported so as to be mutually independent and have inner surfaces thereof;
a trunnion having a pivot shaft disposed in a direction perpendicular to a center axis of the input and output disks, the trunnion swinging on the pivot shaft;
a displacement shaft including:
a support shaft portion swingably supported on the trunnion; and
a pivot shaft portion disposed in parallel and eccentric with the support shaft portion, the pivot shaft portion protruded from an inner surface of the trunnion;
a plurality of power rollers pinched between the inner surfaces of the input and output disks and rotatably supported on the pivot shaft portion; and
a thrust rolling bearing provided between an outer surface of the power roller and the inner surface of the trunnion, the thrust rolling bearing including:
an outer ring;
an inner ring raceway formed on the outer surface of the power roller;
an outer ring raceway formed on the inner surface of the outer ring; and
a rolling element rollably disposed between the inner ring raceway and the outer ring raceway,
wherein the displacement shaft and the outer ring of the thrust rolling bearing are integrated and
metal flows extends along with the outer ring raceway and a surface of a root portion of the support shaft portion of the displacement shaft.
